(19) United States
(12) Patent Application Publication
(10) Pub. No.: US 2013/0105078 A1
(43) Pub. Date: May 2, 2013

(54) ROAD STUD PLACEMENT AND REMOVAL SYSTEM

(71) Applicant: Keith Dawson, York (GB)

(72) Inventors: Keith Dawson, York (GB); Brian Godfrey, York (GB); John Wolstencroft, Cambs (GB)

(73) Assignee: Prismo Road Markings Limited, Lancashire (GB)

(21) Appl. No.: 13/285,943

(22) Filed: Oct. 31, 2011

(51) Int. Cl. E01C 23/16; B32B 37/14; B32B 38/18; B05C 5/04; B32B 37/12

(52) U.S. Cl. 156/297; 118/620; 404/93

(57) ABSTRACT

A road stud placement and removal system includes an induction heating system to quickly heat an appropriate quantity of road stud adhesive. A specific volume of the road adhesive may be dispensed by the system on the road surface, and a road stud placement assembly may automatically place a road stud in the dispensed adhesive. The stud placement system is operable to automatically dispense stud adhesive and place road studs in succession. According to certain embodiments, the placement system may be supported by a traffic safety vehicle, which enables the worker to automatically place the road studs while driving the vehicle.

### BACKGROUND

Raised road studs are used to mark roads. Raised road studs provide a reflective indicator increasing the visibility of the marker to a driver. They may be secured to a road surface using an adhesive material that must be melted before it is applied. It then hardens as it cures, and cements the stud to the roadway. The adhesive may be from tar, asphalt, bitumen, and similar substances, as well as mixtures of these. The molten adhesive must be applied hot, so that a road stud can be placed on the adhesive, and the adhesive will cool and set and adhere the road stud to the road surface. The adhesive is heated in boilers that are typically a half ton in size. The boilers are heated using a gas burner and an open flame, and it may take approximately one hour to heat the adhesive to the appropriate temperature. Moreover, the boilers maintain the adhesive at its melting temperature as long as road studs are being applied to mark a road. Traffic safety workers manually apply the molten adhesive by and manually secure a road stud to the road surface. Some road stud marking jobs may require the hand application of hundreds of road studs. Often, the traffic safety workers perform this task near live lanes of traffic.

### SUMMARY

One exemplary embodiment of a road stud placement and removal apparatus comprises an induction heating system for heating a quantity of roadway adhesive for application to a road surface. The embodiment also comprises an applicator for depositing a predetermined quantity of adhesive to the roadway surface. A specific volume of the road adhesive may be dispensed by the system on the road surface, and a road stud placement assembly may automatically place a road stud in the dispensed adhesive. The stud placement system is operable to automatically dispense stud adhesive and place road studs in succession. According to certain embodiments, the placement system may be supported by a vehicle, which enables automatic placement of roadway studs at predefined intervals as the vehicle moves.

According to another exemplary embodiment, a road marker or stud placement apparatus and an apparatus for removing studs from the roadway surface are mounted to the same vehicle. Thus, previously applied studs maybe removed prior to placement of new studs. For one example, the stud removal apparatus comprises a scraper blade for separating a previously applied and fixed road stud from the road surface. The separated road stud may be directed by a rotating brush or other mechanism for sweeping the stud toward and onto a conveyor carried by the vehicle or other means for transporting the separated road stud to a holding or storage container.

An induction heating system according to embodiments of the present disclosure may be used to heat any material used in road marking For example, the induction heating system may be used to heat a marking thermoplastic material so it can be applied to a road surface. The induction heating system may also be used to heat air from a compressed air source. This air may be emitted to dry the road surface before the thermoplastic is applied.

### BRIEF DESCRIPTION OF THE DRAWINGS

FIG. 1 is an environmental view of a vehicle equipped with road stud placement and removal assemblies according to embodiments of the present disclosure.

FIG. 2 is a schematic illustration of a road stud placement assembly according to an embodiment of the present disclosure.

FIGS. 3A-3D are isometric views of a the road stud placement assembly of FIG. 1 illustrating a sequence used to adhere a road stud to the surface of a road.

FIG. 3E is a cross-sectional view of the nozzle shown in FIGS. 3A-3D.

FIG. 4 is a schematic illustration of a road stud removal system according to an embodiment of the present disclosure.

FIG. 5 is a schematic illustration of an induction heating system used to dry a road surface and apply a heated road marking material to the dried road surface.

### DETAILED DESCRIPTION

In the following description of a road stud placement and removal system, like numbers refer to like parts.

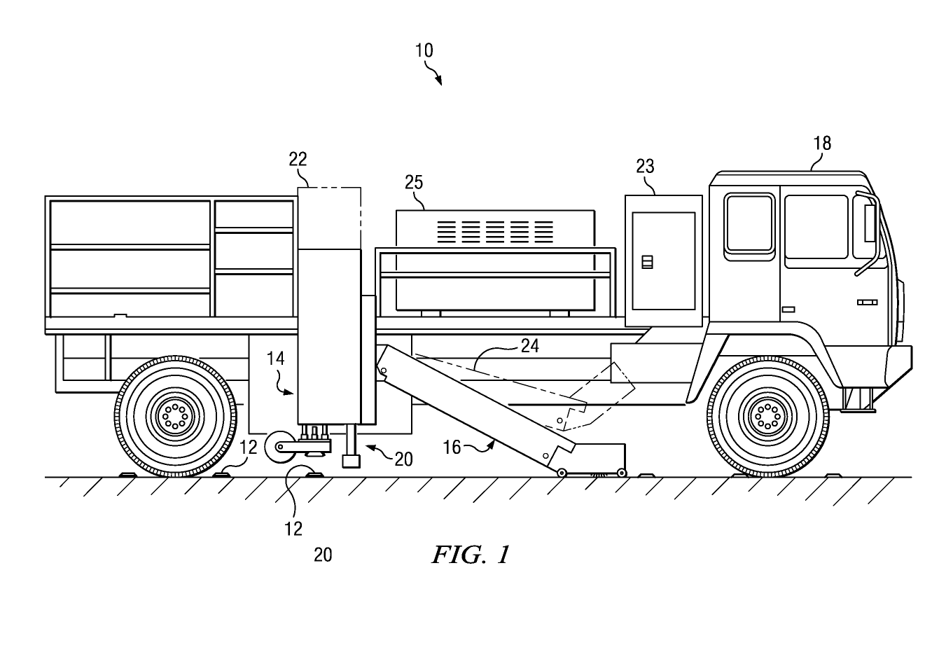

FIG. 1 illustrates an environmental view of a road stud placement and removal system 10 according to an embodiment of the present disclosure. The road stud placement and removal system 10 reduces the amount of adhesive or other material to be melted in order to mark a road. The road marking may be done by placing a road stud or lining the road with a thermoplastic or resin known in the art to provide durable road markings. By heating only the required amount of adhesive or other material, the need for a road marking vehicle to accommodate 40, 60, and 100 gallon boilers may be eliminated. The required amount may be an amount of solid adhesive sufficient to secure a predetermined number of road studs. After that number is placed, more solid adhesive material may be heated in order to place more road studs.

Moreover, heating and melting stud adhesive and other material with induction heating as described further below eliminates the need to have a naked flame associated with propane gas or oil burners used to heat the boilers. Heating only the required amount of material in an induction heating system may increase the efficiency, reduce the waste, and reduce the pollution associated with conventional road marking techniques and equipment. In addition, the material may be heated and melted as needed, thereby eliminating the energy and equipment needed to maintain the elevated temperature throughout the process of marking a substantial portion of a roadway.

The road stud placement and removal system 10 shown in FIG. 1 includes a vehicle 18, a stud placement assembly 14 incorporating an induction heating system, and a stud removal assembly 16. The stud removal assembly 16 and the stud placement assembly 14 automate removing fixed or temporary roadway studs 12 and attaching new studs to the road surface. Conventional road stud placement is a manual task in which a boiler is used to heat the roadway adhesive so that it may be manually applied to the road surface. A stud may then be pressed into the molten roadway adhesive where it will adhere to the road surface. The stud placement assembly 14 automatically dispenses a predetermined amount of adhesive and automatically places a road stud 12 into the dispensed molten adhesive. The assembly 14 may also apply appropriate pressure such that the road stud 12 is sufficiently pressed into the adhesive. The adhesive may then cool, cure, and harden keeping the stud firmly in place to mark the road surface.

Conventional boiling for melting solid bitumen and similar adhesives is replaced with an induction heating system 20. Using induction heating, the cold block of solid adhesive 26 may be heated up in approximately 30 seconds as opposed to conventional techniques which require a boiler and an hour or more to heat the adhesive to its melting point. The induction heating system 20 may be electrically coupled to a high frequency electric power supply 25, which may be located on the vehicle 18. The high frequency power supply is, in this example, comprised of a diesel powered generator for generating current that is pushed through a switching circuit in order to generate a high frequency current for inducing heating of adhesive when placed within a crucible in which blocks of adhesive have been placed. Induction heating using the current from the power supply 25 heats the roadway adhesive to a melting temperature relatively more quickly than conventional boilers. Less adhesive can be melted shortly before use, reducing the need to melt large quantities of it in advance.

In operation, the road stud placement and removal system 10 is adapted for being driven on a vehicle 18 to the location where studs are to be placed or replaced. The illustrated vehicle 18 is an example of a heavy duty traffic safety vehicle. In this example, the stud placement and removal system is placed on the bed of a truck. Examples of other vehicles for transporting system 10 include trailers and combinations of trailers with tractors and other types of vehicles. In another exemplary embodiment, the system 10 is placed on a trailer pulled by a motor vehicle or tractor, the combination of which is considered to be a vehicle 18. Embodiments of the present disclosure may incorporate any appropriately sized vehicle.

In the illustrated example, the stud placement assembly 14 and the stud removal assembly 16 are each adapted to be moved between a stowed position and an operational position. During transportation, the stud placement assembly 14 and the stud removal assembly 16 may be retracted into their respective stowed positions 22 and 24 in which they are raised. Optionally, one or both assemblies may also be shifted inboard. Once the vehicle 18 is at the appropriate location, the stud placement assembly 14 and/or the stud removal assembly 16 are deployed to their operational positions as shown in FIG. 1, in which they are lowered close to the roadway. They may also be moved outwardly. In certain embodiments, the stud removal assembly 16 may be deployed while the stud placement assembly 14 remains in its retracted transportation position 22, and vice versa. According to other embodiments and other applications of the system 10, both the stud placement assembly 14 and the stud removal assembly 16 are deployed in their operational positions as shown in FIG. 1. This may allow stud placement to occur almost immediately after a temporary stud is removed.

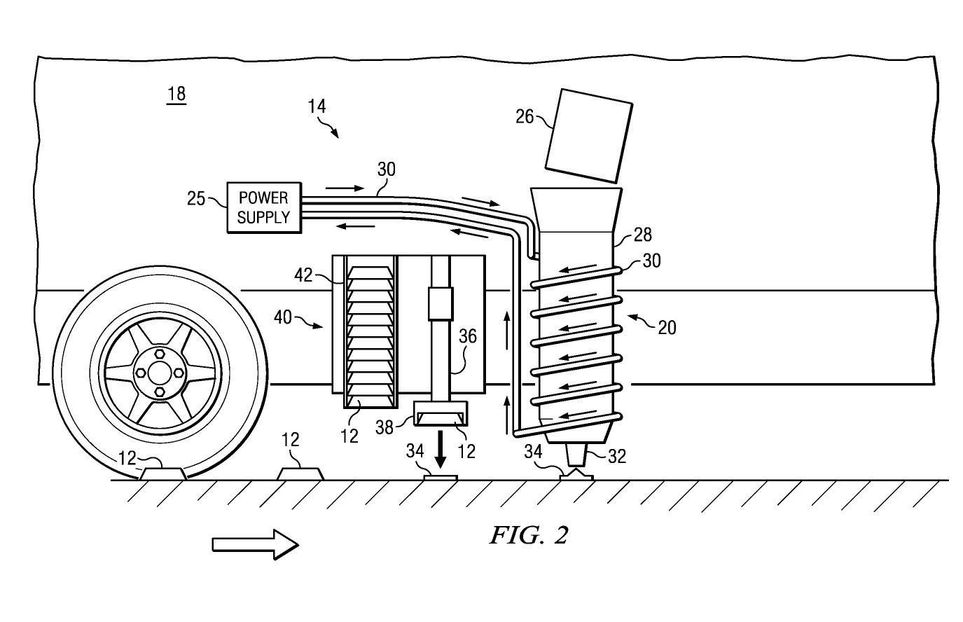

FIG. 2 is a schematic illustration of certain components of the stud placement assembly 14 shown in FIG. 1. The stud placement assembly 14 is shown with a portion of the vehicle 18. The stud placement assembly 14 includes the induction heating system 20 and a stud applicator assembly 40. In this example, the induction heating system 20 uses an induction heating method to melt a block of solid roadway adhesive, such as bitumen, 26 so that it can be dispensed on the roadway surface. The solid adhesive 26 may be a block or other form of bitumen or solid mixtures containing bitumen and other materials that may be applied to a road surface to serve as stud adhesive. In other embodiments, the solid adhesive 26 may be any other material known in the art for adhering road features, such as road studs to the surface of a road. The solid adhesive 26 may be received into a crucible 28 where it may be heated using induction heating.

The induction heating occurs when the power supply 25 supplies a current through the coil 30. The coil may be a copper pipe, wire, or other suitable material known in the art to carry a current for induction heating. The coils 30 carry a high frequency, alternating electric current through the coil 30 that is wrapped around the crucible 28. The crucible may be a generally cylindrical conductor that can be heated through the induction heating method. In certain embodiments, the crucible 28 may be formed from steel or another type of metal. The alternating electric current passing through the coil 30 generates a magnetic field in the vicinity of the crucible 28. The magnetic field creates currents in the crucible 28. These currents flow in opposite directions through the crucible 28. The resistance of the currents flowing in opposite directions in the crucible 28 causes the crucible 28 to heat. The coils 30 may remain cool. By heating the crucible 28 using this induction heating method, the crucible 28 may be heated to a point where the adhesive block 26 reaches its melting temperature. This may be a quick method of heating the crucible 28 and allowing the adhesive block 26 to reach its melting temperature. It may be much faster than the conventional method of heating the adhesive block in a boiler and having to maintain the elevated temperature of the boiler to keep the adhesive molten so that it may be applied to the road surface. A measured amount of the molten adhesive or bitumen 34 may be dispensed by the dispenser nozzle 32 onto the road surface. A road stud 12 may be pressed into the dispensed molten adhesive 34 and once cured, cement the road stud 12 to the road surface.

The stud placement assembly 14 also includes the stud applicator assembly 40. The stud applicator assembly 40 includes a stud magazine 42 and a stud placement cylinder 36. Once the molten adhesive 34 is dispensed on the road surface, the assembly 14 may translate such that a stud gripper 38 is positioned over the molten adhesive 34. The stud gripper 38 may receive a road stud 12 from the stud magazine 42 and retain the stud 12 in its gripper jaws. Once in this position, the stud placement cylinder 36 may cause the stud gripper 38 to descend towards the molten adhesive 34. Once a particular height is reached, the stud placement cylinder 36 may apply appropriate pressure such that the stud 12 seats into the molten adhesive 34. Then, the stud gripper 38 may release the stud, and the stud 12 will remain in the molten adhesive 34. This process of dispensing the molten adhesive 34 and placing the road stud 12 may be repeated as the vehicle 18 moves along the path where the studs are needed. This automatic road stud application may eliminate the dangerous condition of having a worker manually applying adhesive and road studs near live lanes of traffic.

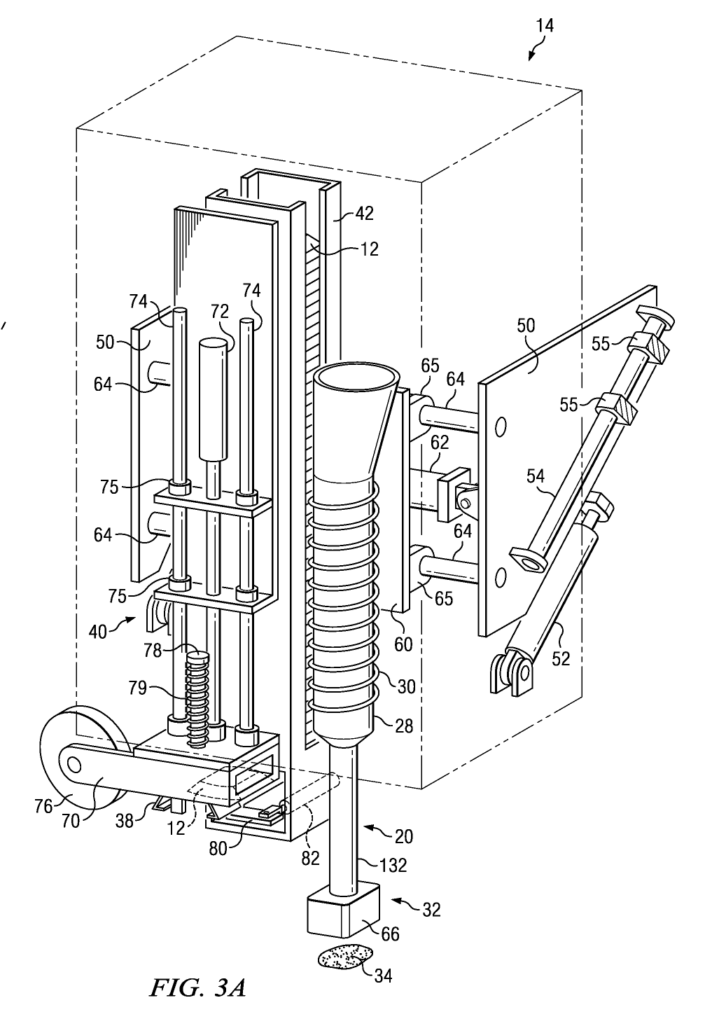

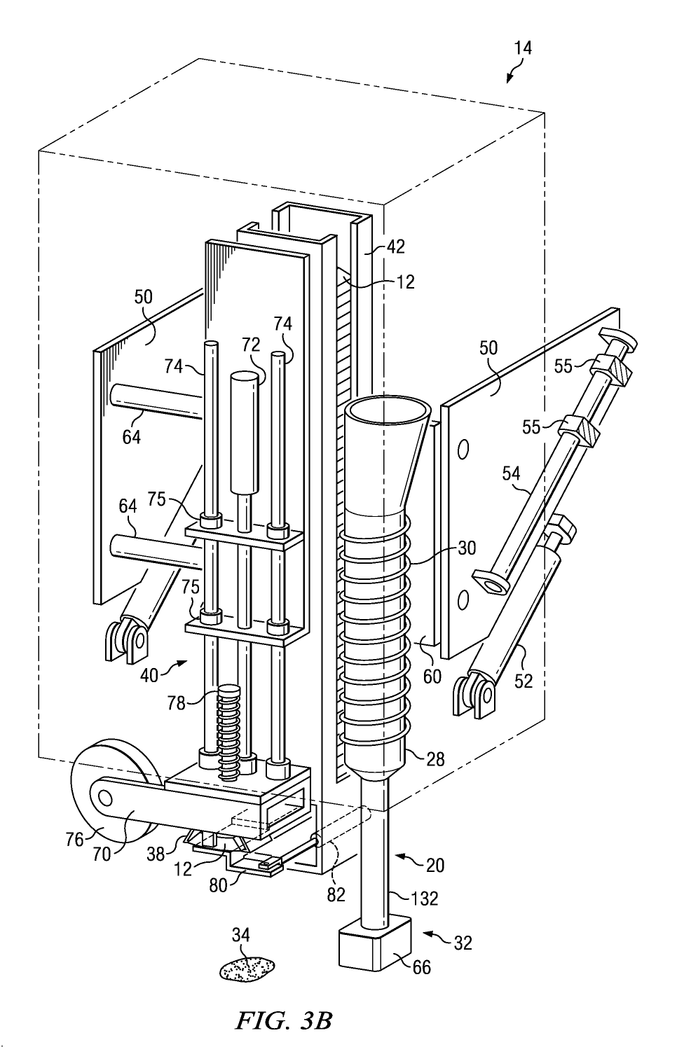

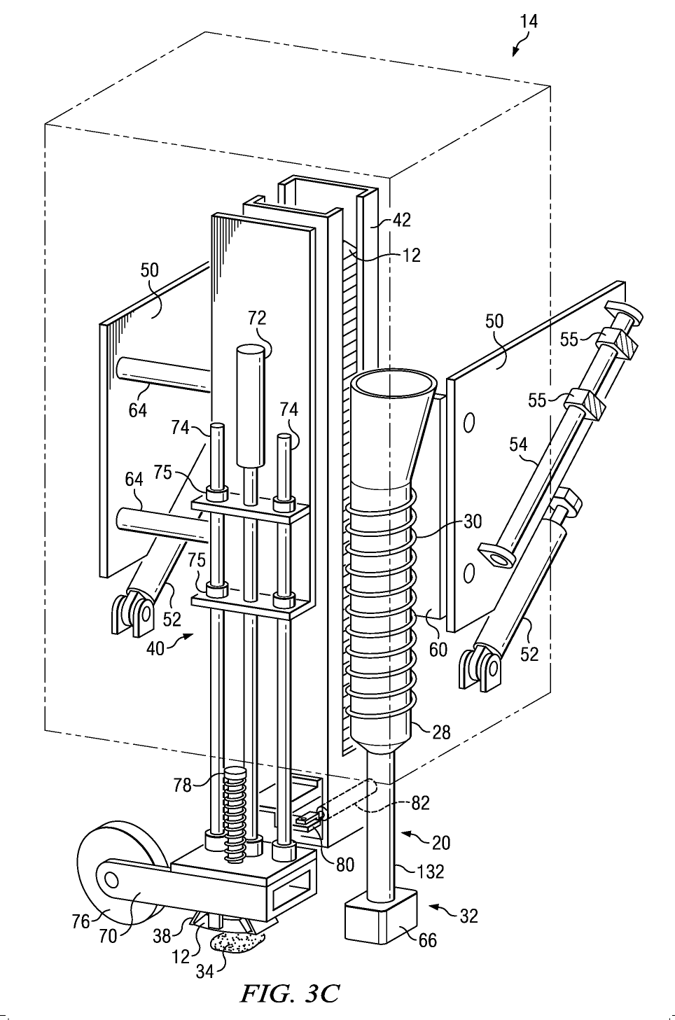

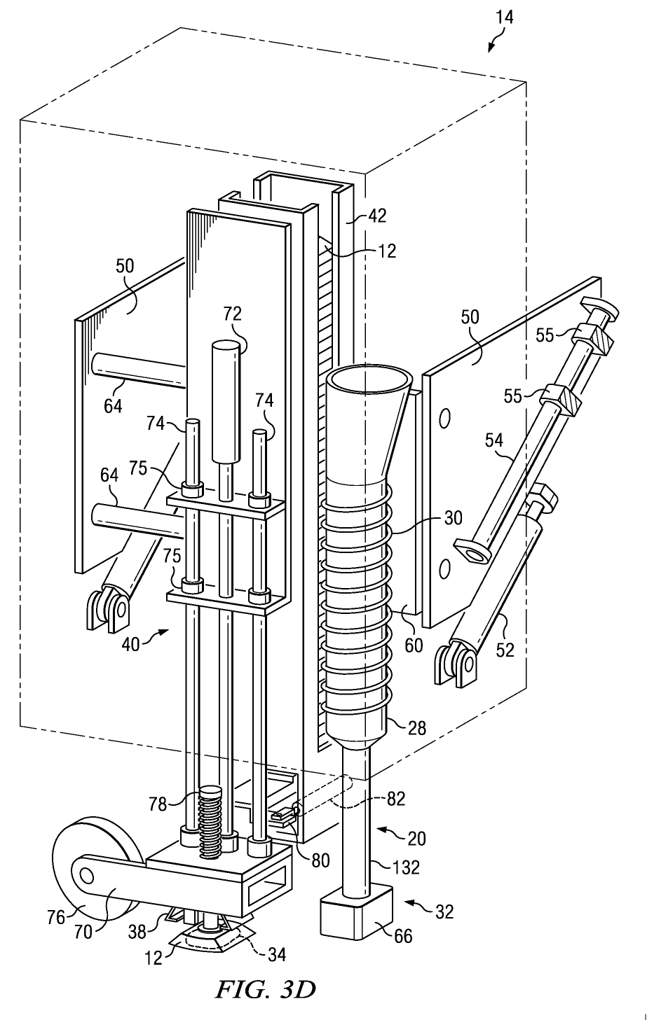

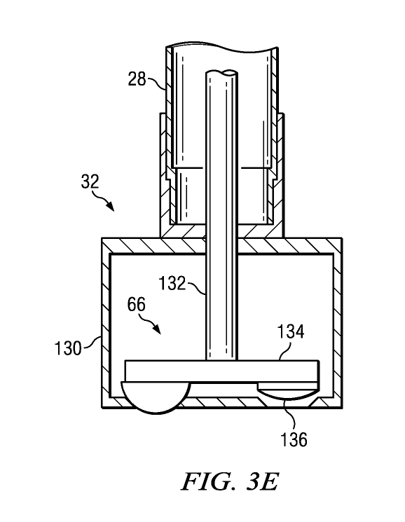

FIGS. 3A-3D illustrate an embodiment of the stud placement assembly 14 and show a sequence that may be used to dispense molten adhesive and place a stud 12 into the molten adhesive. The adhesive may then cure, harden and cement the stud 12 to the road surface. The stud placement assembly 14 includes the induction heating system 20 and the stud applicator assembly 40. As previously discussed, the adhesive block (not shown) may be received by a receiving portion of the crucible 28. The crucible 28 holding the adhesive block may be heated through the induction heating method previously described by passing an alternating current through the coils 30. Once the adhesive reaches the melting temperature, gravity may cause it to flow downward where it may pool in a portion of the dispenser nozzle 32. The dispenser nozzle 32 includes a molten adhesive metering valve 66, as shown in more detail by FIG. 3E. According to certain embodiments, the molten adhesive metering valve 66 may ensure that only a specific predetermined amount of adhesive is permitted to flow through the valve 66 and be dispensed on the road surface.

FIG. 3A shows the stud placement assembly 14 in its deployed position. The stud placement assembly 14 moves from its transport position 22 (FIG. 1) to the deployed position illustrated in FIG. 3A by moving generally downward and outward away from the vehicle 18. A locking bolt may be used to secure the assembly 14 in the deployed position. The components of the stud placement assembly 14 may be coupled to a deployment carriage 50. The deployment carriage 50 may be movable along deployment guide rails 54. The guide rails 54 may be formed from hardened stainless steel. The motion of the deployment carriage 50 may be powered by a deployment cylinder 52. In certain embodiments, the deployment cylinder 52 (and other cylinders of stud placement assembly 14) may be a pneumatic cylinder that powers the deployment carriage 50 and the components of stud placement assembly 14 to move a specific predetermined distance along the deployment guide rails 54 to move from the transport position 22 to the deployment position shown. The deployment bearings 55 may move linearly along the deployment guide rails 54 to direct the motion of the deployment carriage 50.

Once a specific volume of adhesive has been dispensed, the induction heating system 20 and the stud applicator 40 may translate linearly such that the stud gripper 38 is positioned over the molten adhesive 34. This position is illustrated in FIG. 3B.

The components of the stud placement assembly 14 are secured to a transfer carriage 60. Lateral movement of the transfer carriage 60 may be guided by transfer guide rails 64 and may be powered by transfer cylinder 62 similar to the deployment cylinder 52, the transfer cylinder 62 may be a pneumatic cylinder that, when activated, can drive the transfer carriage 60 and the components to which it is coupled laterally a predetermined distance. Transfer bearings 65 may be attached to the transfer carriage and may slide linearly along the transfer guide rails 64.

Prior to or during this translation, an escapement slide 80 may retrieve a stud 12 from the stud magazine 42 and slide the stud 12 so that it is received and secured by the stud gripper 38. In this manner, after the translation, the stud is positioned directly over the molten adhesive 34 such that it may be pressed into the molten adhesive and applied to the road surface.

Once the stud 12 and the stud gripper 38 are positioned over the molten adhesive, the stud placement carriage 70 may be lowered. The lowering of the stud placement carriage may be directed by the stud placement guide rails 74 and may be powered by the stud placement cylinder 72. As with the other drive cylinders, stud placement cylinder 72 may be pneumatically powered to drive the stud placement carriage downward towards the road surface.

The stud placement carriage 70 may include a height gauge wheel 76. As the stud placement carriage 70 is lowered towards the road surface, the first contact made with the surface is by the height gauge wheel 76. This contact may be electrically communicated to the stud placement cylinder 72 indicating that the stud placement carriage has reached a certain known height above the road surface.

To ensure proper pressure is applied such that the stud 12 is properly seated in the molten adhesive 34, a lower section of the stud placement carriage 70 may be free to move in a vertical direction constrained by vertical bar 78 and having a spring 79. This free moving lower carriage and spring 79 may ensure that a proper force is applied to seat the stud 12 into the molten adhesive as shown in FIG. 3D. Once the stud is in the molten adhesive 34, the stud gripper 38 releases the stud 12 and the stud gripper 38 is retracted to the stud load position and is ready to receive the next stud.

This process can be used to position one stud 12 in one specific volume of molten adhesive 34. This process may be repeated once the vehicle 18 moves a predetermined interim along the required path. In this manner, roadway studs may be automatically positioned and fixed to the road surface without requiring manual application of molten adhesive from a hot boiler and manual positioning and placement of a road stud. In an alternate embodiment, the stud placement assembly 14 may be configured to cement two studs 12 parallel to each other to create a double line roadway marker.

FIG. 3E is a cross-sectional view of the dispenser nozzle 32 shown in FIGS. 3A-3D. The dispenser nozzle 32 includes a molten adhesive pooling box 130. The molten adhesive that is heated in the crucible 28 flows downward within the crucible 28 and collects in the molten adhesive pooling box 130. In certain embodiments, gravity may provide the only force to cause the molten adhesive to flow. In other embodiments, a pressure may be applied to the molten adhesive to assist the downward flow. Inside the molten adhesive pooling box 130 is a molten adhesive metering valve 66. The molten adhesive metering valve 66 may be actuated by a valve drive shaft 132. The valve drive shaft 132 may be raised to break a seal 136 sealing an opening in the molten adhesive pooling box 130. In certain embodiments, the opening may be very small, as small as five or six millimeters, to allow the molten adhesive to flow through the adhesive dispenser nozzle 32. The molten adhesive may collect and pool in the molten adhesive pooling box 130 and remain there until it is needed and the molten adhesive metering valve 66 opens to allow a predetermined amount of adhesive to be dispensed on the road surface. The molten adhesive metering valve 66 may be closed when the valve drive shaft 132 is moved downward and the seal between the seal 136 and the opening in the molten adhesive pooling box 130 is reestablished. The valve drive shaft 132 may extend all the way through the crucible 28 where it may be activated by a pneumatic cylinder similar to the driving components moving the other assemblies described herein.

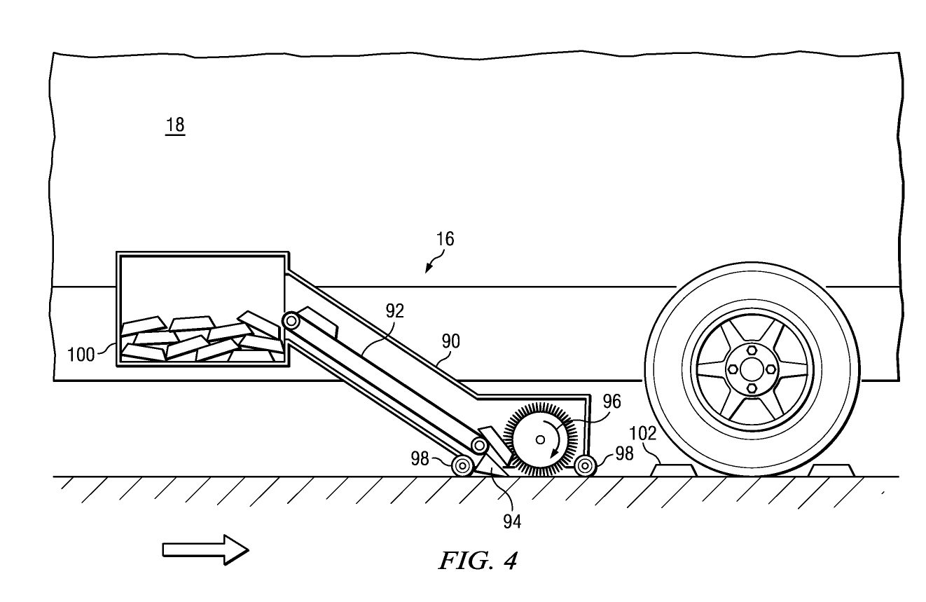

FIG. 4 is a schematic illustration of the stud removal assembly 16 shown in FIG. 1. The stud removal assembly 16 includes a stud container 100 and a housing 90. The housing 90 may support guide wheels or rollers 98. The guide wheels 98 may roll across the road surface in the direction of travel of the traffic safety vehicle 18. Also supported by the housing 90 may be a removal blade 94. The removal blade 94 may be a self-hardening metal blade that glides along or a short distance above the road surface. As the removal blade 94 moves with the vehicle 18, it may scrape and remove a fixed or temporary road stud 102. The blade 94 may wedge underneath the stud 102 and separate it from the road surface. After the stud 102 is separated from the road surface by the removal blade 94, a rotating brush 96 may sweep the stud 102 backwards as the brush rotates clockwise. A clockwise rotation of the brush 96 directs motion of the separated stud onto a conveyor belt 92. The conveyor belt 92 may be positioned at an angle such that the removed stud is directed upward towards the stud container 100. In other embodiments, a series of separate conveyor belts may transport the removed stud to any suitable location on the vehicle 18 for collection and storage. Studs removed from the road surface may collect in the stud container 100 and be disposed of by removing and emptying the stud container 100. As previously stated, the stud removal assembly 16 may be used in connection with the stud placement assembly 14. In this operation, temporary road studs 102 may be removed by the stud removal assembly 16 and following behind on the same vehicle 18, permanent roadway studs may be placed and secured in stud adhesive by the stud placement assembly 14.

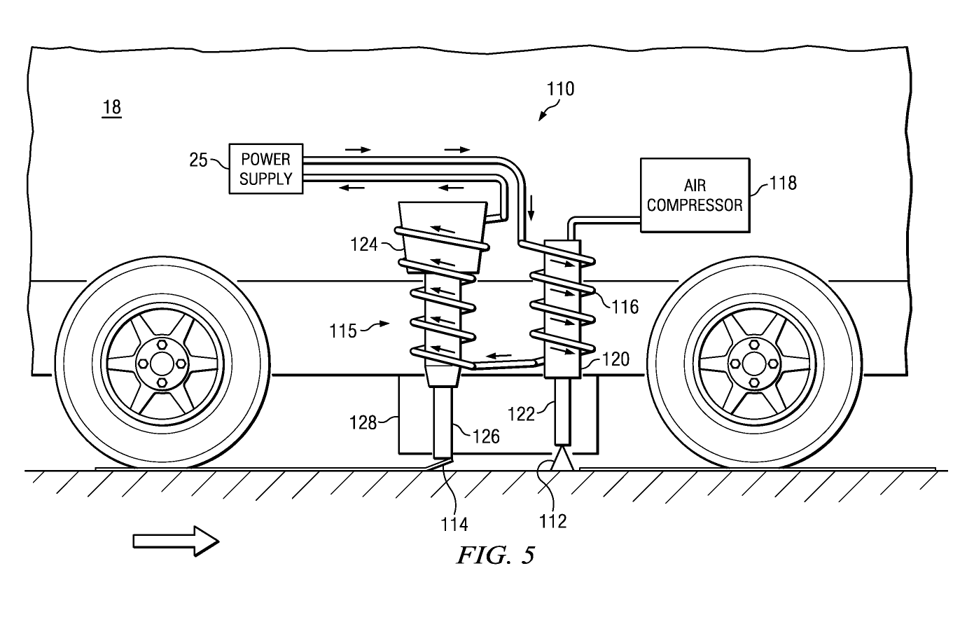

FIG. 5 is a schematic illustration of an alternate embodiment of applying road markings to a road surface, which employs the induction heating system of the present disclosure in connection with a vehicle 18. The induction heating system 115 may be used to heat air from an air compressor 118. The induction heating system may also heat and/or melt a thermoplastic so that the thermoplastic may be applied to a road surface. FIG. 5 illustrates a thermoplastic applicator assembly 110 that may be coupled to the vehicle 18. The thermoplastic applicator assembly 110 may provide a heated air stream 112 directed over a portion of the roadway surface. The super heated air stream 112 may dry the road surface so that a thermoplastic layer 114 may be laid evenly and properly applied to the road surface even in wet or rainy conditions. Thermoplastic may be used for a variety of road marking applications, for example, the center line of a roadway or marking boundaries of a lane of traffic, etc. In addition, a change in the color of the thermoplastic may be made quickly and easily.

Similar to the induction heating system 20 that was described with respect to the previous embodiments, the air for the heated air stream 112 and the thermoplastic layer 114 may be heated with the induction heating system as described previously with regard to the stud placement assembly 14. To this end, the coils 116 may be copper pipes that carry a high frequency alternating electric current from a power supply 25 that is located on the vehicle 18. The current travels through the coils 116 and in so doing an air heater 120 is heated via induction heating. The air heater may be a cylindrical component made of a conductive material, such as a metal like steel. Air from an air compressor 118 provides the air flow through the air heater 120 where it can be heated to an elevated temperature sufficient to dry a wet road surface. The heated air 112 may be emitted through an air nozzle 122. The air nozzle 122 may be positioned a short distance above the road surface to be dried with the heated air stream 112.

Positioned behind the air nozzle 122 may be a dispenser nozzle 126. The dispenser nozzle 126 may lay a strip of heated thermoplastic 114 on the roadway that was just dried by the heated air stream 112. The thermoplastic 114 may be heated by the induction heating system 115 to a temperature that causes the material to flow. The induction heating system 115 may employ the same coil 116 that wraps around the air heater 120. According to an alternate embodiment, a different coil may be electrically coupled to the power supply 25 and the current from the power supply 25 may travel through the separate coils to create the induction heating in the thermoplastic heater 124. The current may travel through the coil 116 in the direction indicated by the arrows to ensure induction heating of the cylindrical metallic thermoplastic heater 124.

In certain embodiments, the air nozzle 122 and the dispenser nozzle 126 may be protected from rain or road debris by a rain hood 128. According to embodiments of the present disclosure, the induction heating system may be used to heat any type of coating or other material such that it flows and can be applied to a surface.

Heating with the induction heating system 115 may be highly efficient because only the thermoplastic heater 124 and/or the air heater 120 are heated. The coils 116 themselves may not get hot. Also, the induction heating system 115 uses no flames or flammable materials. Moreover, fumes that are associated with conventional thermoplastic road markings may be greatly reduced or eliminated.

The foregoing description is of exemplary and preferred embodiments. The invention, as defined by the appended claims, is not limited to the described embodiments. Alterations and modifications to the disclosed embodiments may be made without departing from the invention. The meaning of the terms used in the claims are, unless expressly stated otherwise, intended to have ordinary and customary meaning and are not intended to be limited to the details of the illustrated structures or the disclosed embodiments.

What is claimed is:

1. An apparatus for dispensing an adhesive for bonding a road stud to a surface, comprising:
a plurality of coils surrounding a crucible, the plurality of coils configured to carry a current that causes induction heating of the crucible, the crucible configured to contain a solid adhesive and heat the solid adhesive to a melting point; and
a nozzle coupled to the crucible, the nozzle having a metering valve operable to dispense a predetermined amount of molten adhesive for bonding a road stud to a surface.

2. The apparatus of claim 1, wherein the nozzle further comprises a molten adhesive pooling box, the molten adhesive flowing from the crucible and collecting in the molten adhesive pooling box.

3. The apparatus of claim 2, wherein gravity causes the molten adhesive to flow into the molten pooling box.

4. The apparatus of claim 1, wherein the metering valve opens no more than seven millimeters to dispense the molten adhesive.

5. The apparatus of claim 1, further comprising a power supply operable to supply the current to the plurality of coils, and wherein the current is a high frequency alternating current.

6. A vehicle for placing road studs, comprising:
a vehicle;
an adhesive dispenser supported by the vehicle and comprising:
a plurality of coils surrounding a crucible, the plurality of coils configured to carry a current that causes induction heating of the crucible, the crucible configured to contain a solid adhesive and heat the solid adhesive to a melting point;
a nozzle having a metering valve operable to dispense a plurality of predetermined amounts of molten adhesive onto a road surface; and
a stud placement assembly supported by the vehicle and comprising:
a stud magazine configured to contain a plurality of road studs; and
a stud gripper operable to receive each of the plurality of road studs from the stud magazine and successively place each of the plurality of road studs on respective predetermined amounts of the dispensed molten adhesive.

7. The vehicle of claim 6, wherein the molten adhesive dispenser further comprises a molten adhesive pooling box, the molten adhesive flowing from the crucible and collecting in the molten adhesive pooling box.

8. The vehicle of claim 6, wherein the stud placement assembly further comprises a height gauge operable to detect a predetermined distance above the road surface.

9. The vehicle of claim 6, further comprising a stud removal assembly supported by the vehicle, the stud removal assembly comprising:
a housing supported by the vehicle; and
a blade supported by the housing and configured to separate a secured road stud from the road surface to which the road stud is secured.

10. The vehicle of claim 9, wherein the stud removal assembly further comprises:
a rotating brush supported by the housing;
a conveyor supported by the housing; and
the rotating brush configured to direct a separated road stud onto the conveyor, the conveyor transporting the separated road stud to a storage container.

11. A road marking apparatus, comprising:
an induction heating system configured to be supported by a road marking vehicle, the induction heating system comprising a plurality of coils surrounding a crucible, the plurality of coils configured to carry a current that induces heating of the crucible, the crucible configured to contain and heat a material used in road marking

12. The apparatus of claim 11, wherein the material is a thermoplastic for marking a road.

13. The apparatus of claim 11, further comprising a power supply configured to be supported by the road marking vehicle and being operable to supply the current to the plurality of coils, the current being a high frequency alternating current.

14. The apparatus of claim 13, further comprising:
an air heating member configured to be supported by the vehicle; and
a second plurality of coils surrounding the air heating member, the second plurality of coils configured to carry a second current that induces heating of the air heating member, the air heating member configured to receive air from an air source.

15. The apparatus of claim 14, wherein the first and second plurality of coils conductor are a same conductor coupled to the power supply.

16. A method for securing road studs to a surface, comprising:
receiving a solid adhesive in a crucible, the solid adhesive being an amount sufficient to secure a predetermined number of road studs to a road surface;
heating the crucible such that an internal temperature of the crucible reaches an adhesive melting temperature, the adhesive melting temperature being a temperature that causes the solid adhesive within the crucible to melt;
dispensing the amount of the molten adhesive onto a surface in successive securing quantities;
placing each one of the predetermined number of road studs in the respective successive securing quantities of the molten adhesive; and
allowing the crucible to cool such that the internal temperature is less than the adhesive melting temperature before the crucible receives a second amount of solid adhesive.

17. The method of claim 16, wherein heating the crucible comprises passing a current through a plurality of coils surrounding the crucible, the current causing induction heating of the crucible.

18. The method of claim 16, wherein placing each one of the predetermined road studs comprises:
gripping one of the road studs in a stud gripper;
translating the stud gripper so the one road stud is aligned above one quantity of the molten adhesive; and
lowering the one road stud into the one quantity of the molten adhesive.

19. The method of claim 16, further comprising receiving the molten adhesive in a molten adhesive pooling box before dispensing.

20. The method of claim 16, wherein placing each one of the predetermined number of road studs comprises detecting a predetermined distance above the surface before placing one of the road studs.
